(19) United States
(12) Patent Application Publication
(10) Pub. No.: US 2012/0329308 A1
(43) Pub. Date: Dec. 27, 2012

(54) CONNECTOR TERMINAL

(75) Inventors: SHIH-HUNG CHEN, NEW TAIPEI CITY (TW); LUNG-HAO SUN, NEW TAIPEI CITY (TW); ZHAOYANG ZENG, NEW TAIPEI CITY (TW)

(73) Assignee: GOLDEN BRIDGE ELECTECH INC.

(21) Appl. No.: 13/169,410

(22) Filed: Jun. 27, 2011

(51) Int. Cl. H01R 4/24; H01R 24/00

(52) U.S. Cl. 439/395; 439/626

(57) ABSTRACT

A connector terminal includes a main body having at least one contact section extended from a first end of the main body; a first cable connecting unit horizontally located above an opposite second end of the main body; and a second cable connecting unit vertically extended from an end of the first cable connecting unit in a direction opposite to the main body. With the above structure, the connector terminal can be used with either a 90-degree connector or a 180-degree connector, and to electrically connect cables to the 90-degree connector via the first cable connecting unit or to the 180-degree connector via the second cable connecting unit. Therefore, the connector terminal provides good applicability, and the costs for manufacturing and storing connector terminals can be reduced.

### FIELD OF THE TECHNOLOGY

The present invention relates to a connector terminal, and more particularly to a connector terminal that includes a first cable connecting unit for electrically connecting a cable to a 90-degree connector and a second cable connecting unit for electrically connecting a cable to a 180-degree connector, so that the connector terminal can be used with either a 90-degree or a 180-degree connector to provide good applicability, and the costs for manufacturing and storing connector terminals can be reduced.

### BACKGROUND

The conventional connector terminals can be generally divided into at least three types, namely, soldering terminals, crimping terminals, and piercing terminals. In the case of using soldering terminals and crimping terminals, a lot of time and labor and complicated procedures are required to connect a cable to a connector. Therefore, the piercing terminals are more widely employed in the connector field. A conventional piercing terminal usually includes a main body, a contact section provided at an end of the main body, and a piercing section provided at another opposite end of the main body. The piercing terminal is installed in a terminal seat on a connector to pierce a cable extended through the piercing section, so as to electrically connect the cable to the connector.

Since the conventional connectors can be generally divided into two types, namely, 90-degree and 180-degree connectors, the conventional connector terminals are usually configured as L-shaped or I-shaped to use with the 90-degree and the 180-degree connectors, respectively. Since the L-shaped terminals could not be used with the 180-degree connectors and the I-shaped terminals could not be used with the 90-degree connectors, that is, the L-shaped and the I-shaped connector terminals are not exchangeable with one another in use, it is necessary to prepare two differently configured terminals for assembling to the 90-degree and the 180-degree connectors. As a result, the conventional connector terminals have low applicability and increased costs are needed to produce and store two differently configured connector terminals.

It is therefore tried by the inventor to develop an improved connector terminal that has high applicability and can be used with either a 90-degree or a 180-degree connector to electrically connect cables to the connector, so that it is not necessary to produce and stock two differently configured connector terminals.

### SUMMARY

A primary object of the present invention is to provide an improved connector terminal that can be used with either a 90-degree or a 180-degree connector to electrically connect cables to the connector, so that the connector terminal provides good applicability and the costs for manufacturing and storing connector terminals are reduced.

To achieve the above and other objects, the connector terminal according to the present invention includes a main body having at least one contact section extended from a first end of the main body; a first cable connecting unit horizontally located above an opposite second end of the main body; and a second cable connecting unit vertically extended from an end of the first cable connecting unit in a direction opposite to the main body.

In an embodiment of the present invention, the first cable connecting unit includes a horizontal plate extended in parallel to the main body, two interconnecting sections connecting a first end of the horizontal plate to the second end of the main body, two horizontal insertion slots correspondingly provided on the second end of the main body and the first end of the horizontal plate, two piercing sections provided on two facing sides of each of the two horizontal insertion slots, and a cable guide inlet located between the two interconnecting sections and communicating with the two horizontal insertion slots.

In an embodiment of the present invention, the second cable connecting unit includes a vertical plate vertically extended from an opposite second end of the horizontal plate in a direction opposite to the main body, an outward expanded opening formed on a free end of the vertical plate, a vertical insertion slot formed on the vertical plate along a longitudinal axis thereof and communicating with the outward expanded opening, and two piercing sections provided on two facing sides of the vertical insertion slot.

In another embodiment of the present invention, the second cable connecting unit includes a vertical plate vertically extended from an opposite second end of the horizontal plate in a direction opposite to the main body, a vertical slot formed on the vertical plate along a longitudinal axis thereof and communicating with a free end of the vertical plate, and two clamping sections extended from two facing sides of the vertical slot.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a connector terminal according to a first embodiment of the present invention;

FIG. 2 is a perspective view showing the connector terminal of FIG. 1 viewed from another angle;

FIGS. 3 and 4 illustrate the use of the connector terminal according to the first embodiment of the present invention with a 90-degree connector;

FIGS. 5 and 6 illustrate the use of the connector terminal according to the first embodiment of the present invention with a 180-degree connector; and

FIG. 7 is a perspective view of a connector terminal according to a second embodiment of the present invention.

### DETAILED DESCRIPTION

The present invention will now be described with some preferred embodiments thereof and with reference to the accompanying drawings.

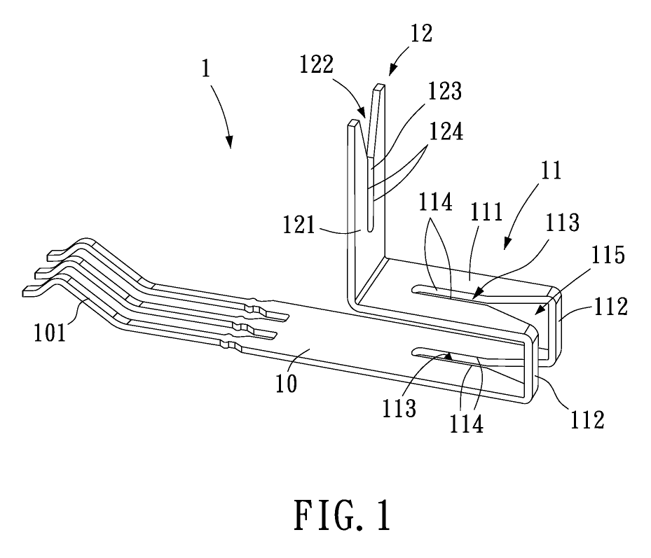

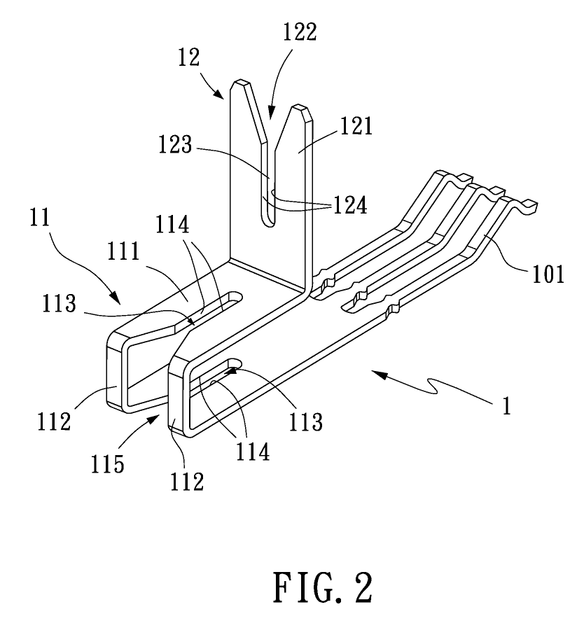

Please refer to FIGS. 1 and 2 that show a connector terminal 1 according to a first embodiment of the present invention viewed from two different angles. As shown, the connector terminal 1 in the first embodiment includes a main body 10, a first cable connecting unit 11, and a second cable connecting unit 12.

The main body 10 has at least one contact section 101 extended from a first end of the main body 10.

The first cable connecting unit 11 is horizontally located above an opposite second end of the main body 10, and includes a horizontal plate 111 extended in parallel to the main body 10, two interconnecting sections 112 connecting a first end of the horizontal plate 111 to the second end of the main body 10, two horizontal insertion slots 113 correspondingly provided on the second end of the main body 10 and the first end of the horizontal plate 111, two piercing sections 114 provided on two facing sides of each of the two horizontal insertion slots 113, and a cable guide inlet 115 located between the two interconnecting sections 112 and communicating with the two horizontal insertion slots 113.

The second cable connecting unit 12 is located perpendicular to the first cable connecting unit 11, and includes a vertical plate 121 vertically extended from an opposite second end of the horizontal plate 111 in a direction opposite to the main body 10, an outward expanded opening 122 formed on a free end of the vertical plate 121, a vertical insertion slot 123 formed on the vertical plate 121 along a longitudinal axis thereof and communicating with the outward expanded opening 122, and two piercing sections 124 provided on two facing sides of the vertical insertion slot 123.

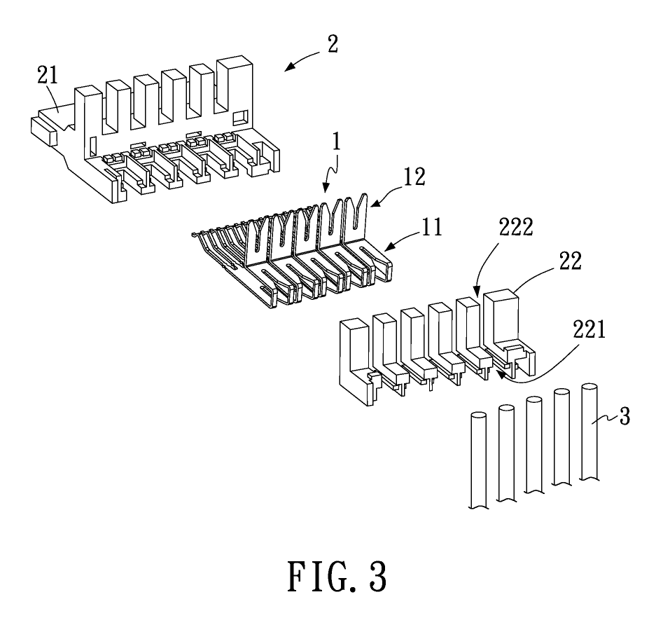

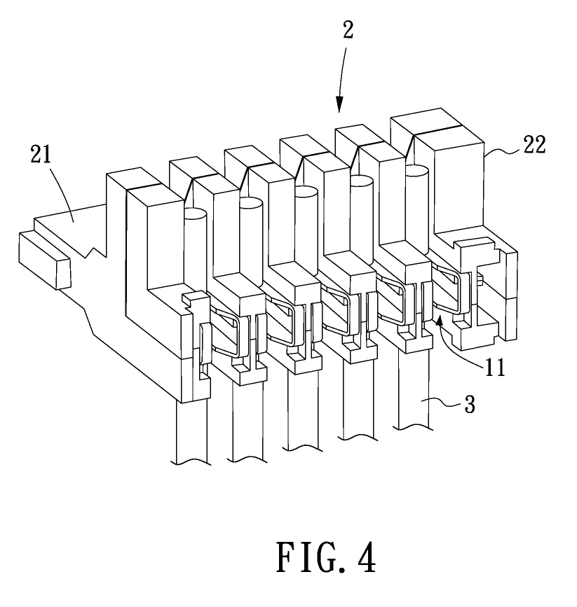

FIGS. 3 and 4 illustrate the use of the connector terminal 1 according to the first embodiment of the present invention with a 90-degree connector 2, such as a SATA connector. Please refer to FIGS. 3 and 4 along with FIGS. 1 and 2. A plurality of cables 3 can be assembled to the 90-degree connector 2 via a plurality of connector terminals 1. To do so, first install the connector terminals 1 on a terminal seat 21, and then connect a rear cover 22 to the terminal seat 21, such that the connector terminals 1 are securely received in between the terminal seat 21 and the rear cover 22. The rear cover 22 is provided with a plurality of horizontal notches 221 and vertical notches 222, which are located corresponding to the cable guide inlets 115 of the first cable connecting units 11 and the outward expanded openings 122 of the second cable connecting units 12, respectively, of the connector terminals 1. In connecting the cables 3 to the 90-degree connector 2, the cables 3 are pushed toward the horizontal notches 221 into the horizontal insertion slots 113 via the cable guide inlets 115. At this point, the piercing sections 114 of the horizontal insertion slots 113 pierce the sheaths 31 of the cables 3, bringing the cores (not shown) of the cables 3 to electrically connect to the connector terminals 1 via the first cable connecting units 11. In this manner, the connector terminals 1 of the present invention can be used with the 90-degree connector 2 to electrically connect cables 3 to the connector 2.

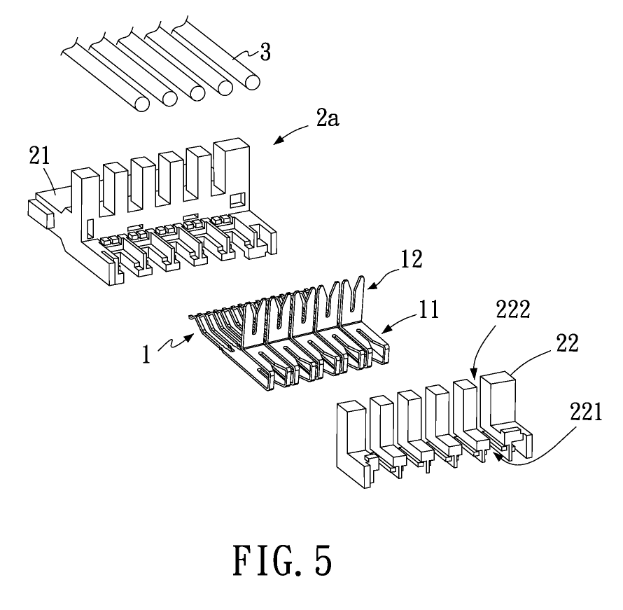

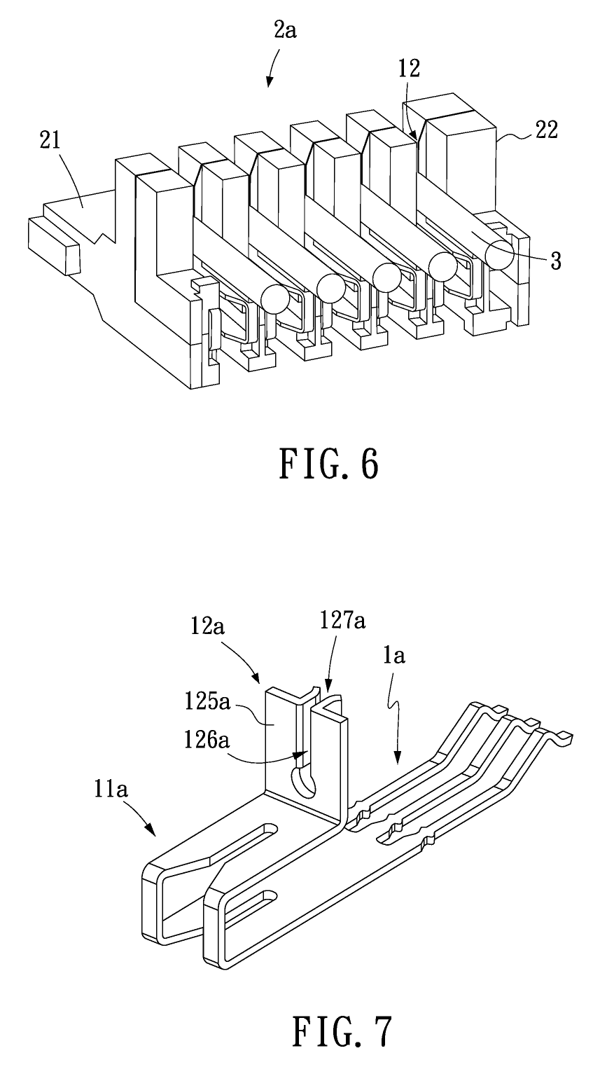

FIGS. 5 and 6 illustrate the use of the connector terminal 1 according to the first embodiment of the present invention with a 180-degree connector 2a, such as a SATA connector. Please refer to FIGS. 5 and 6 along with FIGS. 1 and 2. A plurality of cables 3 can be assembled to the 180-degree connector 2a via a plurality of connector terminals 1. To do so, first securely receive the connector terminals 1 in between the terminal seat 21 and the rear cover 22 as described in the above paragraph. In connecting the cables 3 to the 180-degree connector 2, the cables 3 are pushed toward the vertical notches 222 of the rear cover 22 into the vertical insertion slots 123 of the second cable connecting units 12 via the outward expanded openings 122. At this point, the piercing sections 124 of the vertical insertion slots 123 pierce the sheaths 31 of the cables 3, bringing the cores (not shown) of the cables 3 to electrically connect to the connector terminals 1 via the second cable connecting units 12. In this manner, the connector terminals 1 of the present invention can be used with the 180-degree connector 2a to electrically connect cables 3 to the connector 2a.

FIG. 7 is a perspective view of a connector terminal 1a according to a second embodiment of the present invention. As shown, the connector terminal 1a in the second embodiment is generally structurally similar to the connector terminal 1 in the first embodiment and includes a first cable connecting unit 11a and a second cable connecting unit 12a. The second embodiment is different from the first embodiment in that the second cable connecting unit 12a includes a vertical plate 125a perpendicularly extended from an end of the first cable connecting unit 11a, a vertical slot 126a formed on the vertical plate 125a along a longitudinal axis thereof and communicating with a free end of the vertical plate 125a, and two clamping sections 127a extended from two facing sides of the slot 126a.

In the case the connector terminal 1a is used with a 90-degree connector, the cables (not shown in FIG. 7) are connected to the 90-degree connector by pushing the cables into the first cable connecting unit 11a, so that the cable sheaths are pierced through in the manner as described in the first embodiment. On the other hand, in the case the connector terminal 1a is used with a 180-degree connector, first strip a part of the cable sheaths from the cables to expose bare cores thereof (not shown) and then extend the bare cores through the vertical slots 126a of the second cable connecting units 12a, such that the bare cores are clamped in between the clamping sections 127a to electrically connect to the 180-degree connector via the second cable connecting units 12a. In the above-described manners, the connector terminals 1a of the present invention can also be used with either a 90-degree connector or a 180-degree connector to electrically connect cables to the connector according to actual need in use.

The connector terminal according to the present invention is novel, improved, and practical for use because it includes a first and a second cable connecting unit to enable electric connection of cables to a 90-degree or a 180-degree connector, respectively, via the same connector terminal, allowing the connector terminal of the present invention to have good applicability and be used with either a 90-degree or a 180-degree connector. Meanwhile, with the connector terminal of the present invention, the costs for manufacturing and storing connector terminals can be reduced. The present invention is also industrially valuable because products derived from the present invention would no doubt satisfy the current market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A connector terminal, comprising:
a main body having at least one contact section extended from a first end of the main body;
a first cable connecting unit being horizontally located above an opposite second end of the main body; and
a second cable connecting unit being vertically extended from an end of the first cable connecting unit in a direction opposite to the main body.

2. The connector terminal as claimed in claim 1, wherein the first cable connecting unit includes a horizontal plate extended in parallel to the main body, two interconnecting sections connecting a first end of the horizontal plate to the second end of the main body, two horizontal insertion slots correspondingly provided on the second end of the main body and the first end of the horizontal plate, two piercing sections provided on two facing sides of each of the two horizontal insertion slots, and a cable guide inlet located between the two interconnecting sections and communicating with the two horizontal insertion slots.

3. The connector terminal as claimed in claim 1, wherein the second cable connecting unit includes a vertical plate vertically extended from an opposite second end of the horizontal plate in a direction opposite to the main body, an outward expanded opening formed on a free end of the vertical plate, a vertical insertion slot formed on the vertical plate along a longitudinal axis thereof and communicating with the outward expanded opening, and two piercing sections provided on two facing sides of the vertical insertion slot.

4. The connector terminal as claimed in claim 1, wherein the second cable connecting unit includes a vertical plate vertically extended from an opposite second end of the horizontal plate in a direction opposite to the main body, a vertical slot formed on the vertical plate along a longitudinal axis thereof and communicating with a free end of the vertical plate, and two clamping sections extended from two facing sides of the vertical slot.
